(19) United States
(12) Patent Application Publication
(10) Pub. No.: US 2023/0422140 A1
(43) Pub. Date: Dec. 28, 2023

(54) METHOD FOR OPTIMIZING THE ENERGY EFFICIENCY OF WIRELESS SENSOR NETWORK BASED ON THE ASSISTANCE OF UNMANNED AERIAL VEHICLE

(71) Applicant: University of Electronic Science and Technology of China, Chengdu (CN)

(72) Inventors: Jing REN, Chengdu (CN); Jianxin LIAO, Chengdu (CN); Tongyu SONG, Chengdu (CN); Chao SUN, Chengdu (CN); Jiangong ZHENG, Chengdu (CN); Xiaotong GUO, Chengdu (CN); Sheng WANG, Chengdu (CN); Shizhong XU, Chengdu (CN); Xiong WANG, Chengdu (CN)

(73) Assignee: University of Electronic Science and Technology of China, Chengdu (CN)

(21) Appl. No.: 18/244,925

(22) Filed: Sep. 12, 2023

(30) Foreign Application Priority Data
Apr. 11, 2023 (CN) 202310379847.4

(51) Int. Cl. H04W 40/10; H04W 40/20

(52) U.S. Cl. CPC H04W 40/10; H04W 40/20

(57) ABSTRACT

The present invention provides a method for optimizing the energy efficiency of wireless sensor network based on the assistance of unmanned aerial vehicle, firstly, collecting the state of the WSN through current routing scheme, and inputting the state of the WSN into the decision network of the agent to determine a next hover node; Secondly, based on the location of the next hover node, generating a new routing scheme by the UAV, and sending each sensor node's routing to its corresponding sensor node through current routing by the UAV; Lastly, after all sensor nodes have received their routings respectively, all sensor nodes send their collected data to the hover node through their routings respectively, and the UAV flies to and hovers above the next hover node to collect data through the next hover node, thus the data collection of the whole WSN is completed. Considering that the amounts of data forwarded by the sensor nodes are different, the rates of energy consumptions of the sensor nodes are also different, an online determination of the data collection scheme is adopted. When the residual energies of the sensor nodes relatively have changed, the UAV needs to determine a next hover node and generate a new routing scheme according to current state of the WSN, thus the energy efficiency of wireless sensor network is optimized and the lifetime of the WSN is maximized.

### FIELD OF THE INVENTION

This application claims priority under the Paris Convention to Chinese Patent Application No. 202310379847.4, filed on Apr. 11, 2023, the entirety of which is hereby incorporated by reference for all purposes as if fully set forth herein.

The present invention relates to the field of communication technology, more particularly to a method for optimizing the energy efficiency of wireless sensor network based on the assistance of unmanned aerial vehicle (UAV).

### BACKGROUND OF THE INVENTION

With the continuous development of internet of things (IoT), wireless sensor network (WSN), one of key technologies of IoT, has been widely deployed in various scenarios, such as environment monitoring, industrial control and smart city. In most of the scenarios, the sensor nodes of WSN are temporarily deployed, and powered by batteries which energies are limited, and usually are hard to be recharged or replaced. Therefore, under the condition of limited energies of sensor nodes, how to maximize the lifetime of WSN is very important.

WSN usually is composed of a power-supplied sink node and a plurality of battery-supplied sensor nodes. The data collected by a sensor node will be transmitted to the sink node through single-hop or multi-hop wireless transmission, and then forwarded to the server of a core network by the sink node for processing. The energy consumption of data forwarding accounts for a high proportion of the total energy consumption of a sensor node, so energy consumption in data forwarding stage is of great concern. For the reason that in most of WSNs, multi-hop routing is used to transmit the collected data, and the data forwarded by the sensor nodes which are close to the sink node are much more than the data forwarded by the sensor nodes which are far to the sink node, the sensor nodes which are close to the sink node will consume energy much faster, thereby making the energy distribution of a WSN uneven, which leads to early paralysis of the WSN.

UAV can provide a new solution to WSN's early paralysis to which uneven energy distribution of the WSN leads. As an aerial data collector, UAV has high flexibility and can move fast and barrier-freely. When the energy distribution of a WSN is uneven, UAV can fly to the area where the sensor node has high energy to collect data of the whole WSN. By this way, the energy consumption rates of sensor nodes can be balanced. UAV assists WSN to collect data is a typical application of lengthening the lifetime of WSN

For designing an algorithm for WSN's UAV-assisted data collecting, two key issues are needed to consider. One is how to determine the next location of UAV. With continuous data collecting, the energies of sensor nodes will change continuously, UAV needs to fly to the next location (sensor node) to collect data. The next location needs to be determined. The other is that when the UAV arrives at the next location, how to design the multi-hop routings of sensor nodes to make all sensor nodes transmit data fast to UAV with lower energy consumption. Therefore, how to determine the next location of UAV and how to design the multi-hop routings of sensor nodes according to the continuous energy changes of sensor nodes to maximize the lifetime of WSN is a problem to be solved.

### SUMMARY OF THE INVENTION

The present invention aims to overcome the deficiencies of the prior art, and provides a method for optimizing the energy efficiency of wireless sensor network based on the assistance of unmanned aerial vehicle, under the condition of limited energies of the sensor nodes in WSN, the method can optimize the energy efficiency of wireless sensor network to maximize the lifetime of the wireless sensor network, through choosing a sensor node as the next hover node and generating a new routing scheme.

To achieve these objectives, in accordance with the present invention, a method for optimizing the energy efficiency of wireless sensor network (WSN) based on the assistance of unmanned aerial vehicle (UAV) is provided, comprising:
(1). training an agent which is used to determine a hover node for a UAV in simulation environment
creating a WSN based on an actual deployment in simulation environment, where the WSN has A battery-supplied sensor nodes and a sink node, the sink node is a UAV;
for sensor node nᵢ, i=1, . . . , A, taking the other sensor nodes within its communication range as its neighbor nodes to create a neighbor node list Nᵢ^{nbr}=[mᵢ¹, . . . , mᵢ^{|nbr}^{ᵢ}^{|}], where mᵢ^{c} is the c^{th} neighbor node of sensor node nᵢ, c=1, . . . |nbrᵢ|, |nbrᵢ| is the number of neighbor nodes of sensor node nᵢ;
deploying an agent on the UAV to determine a hover node for the UAV, where the hover node is the sensor node above which the UAV hovers to collect the whole data of the WSN;
training the agent by using an actor-critic reinforcement learning algorithm:
1.1). choosing any of the sensor nodes as the hover node, then based on the locations where the sensors deployed and the neighborhood relationships between the sensors, taking the distances between the sensors as weights to calculate a minimum spanning tree by using Kruskal algorithm, and then in the minimum spanning tree, taking the hover node as a root node to calculate each node's routing by using breadth-first-search algorithm;
1.2). for the different data that the sensor nodes need to collect, designing their probability distributions respectively based on existing prior knowledge to simulate the amount of data collected by the sensor nodes in a real environment, and sending the collected data to the hover node according to their routings at intervals of α seconds, then sending the collected data to the UAV by the hover node, when the UAV hovers above the hover node, meanwhile, simulating the energy consumptions of sensor nodes;
1.3). determining a next hover node and generating a new routing scheme by the UAV when every β rounds of transmissions of the sensor nodes are completed, wherein the process of determining and generating are as follows:
1.3.1). determining a next hover node by the UAV
1.3.1.1). for sensor node nᵢ, i=1, . . . , A, sending its residual energy to the UAV through current routing, and normalizing the residual energy in the UAV to obtain its normalized residual energy Wᵢ, thus a residual energy vector \vec{W}=[W₁, . . . , W_{A}] of the sensor nodes is obtained;
1.3.1.2). obtaining a location vector \vec{L}=[(l₁¹, l₁²), . . . , (l_{A}¹, l_{A}²)] of the sensor nodes by the UAV according to the locations of the sensor nodes, where lᵢ² and lᵢ² correspond to the normalized horizontal coordinate and the normalized vertical coordinate of sensor node nᵢ in a fixed coordinate system respectively;
1.3.1.3). concatenating residual energy vector \vec{W} and location vector \vec{L} to obtain a state vector \vec{S}=\vec{L}+\vec{W} and sending the state vector \vec{S} to the decision network of the agent to calculate a probability vector \vec{P}=[p₁, . . . , p_{A}] by the UAV, where pᵢ, i=1, . . . , A is the probability of choosing sensor node nᵢ as a next hover node by the UAV;
1.3.1.4). randomly generating a floating number within the range of (0,1] by the UAV, wherein if the floating number fall in the j^{th} interval of the cumulative distribution function vector of probability vector \vec{P}, the j^{th} sensor node nⱼ is chosen as the next hover node.
1.3.2). generating a new routing scheme by the UAV
1.3.2.1). for sensor node nᵢ, i=1, . . . , A, using energy-balanced routing protocol (EBRP) algorithm to calculate its hybrid potential field list Uᵢ=[uᵢ¹, . . . , uᵢ^{|nbr}^{ᵢ}^{|}] according to its neighbor node list Nᵢ^{nbr} by the UAV, where uᵢ^{c} is the hybrid potential field between sensor node nᵢ and its neighbor node mᵢ^{c}, the value of uᵢ^{c} stands for the preference of choosing neighbor node mᵢ^{c} as parent node, the bigger the value is, the stronger the preference is;
1.3.2.2). for sensor node nᵢ, i=1, . . . , A, calculating the distance to the next hover node according to its location by the UAV, sorting the sensor nodes in descending order by distance to obtain a node list \hat{N}=[\hat{n}₁, . . . , \hat{n}_{A}], where \hat{n}ᵢ is the i^{th} sensor node in node list \hat{N};
1.3.2.3). maintaining an edge set E by the UAV, wherein the edges of edge set E is used to generate a spanning tree, the root node of the spanning tree is sensor node \hat{n}_{A}=nⱼ, initializing edge set E to an empty set;
1.3.2.4). traversing node list \hat{N} from sensor node \hat{n}₁ to sensor node \hat{n}_{A} to choose a parent node for each sensor node by the UAV, namely directing the sensor nodes to transmit data to the next hover node by choosing parent nodes for the sensor nodes from far to near distance to the next hover node:
1.3.2.4.1). letting i=1;
1.3.2.4.2). for sensor node \hat{n}ᵢ, if i=A, then performing step 1.3.2.5), if i≠A, then performing step 1.3.2.4.3);
1.3.2.4.3). wherein sensor node \hat{n}ᵢ corresponds to sensor node nₖ, sorting hybrid potential field list Uᵢ of sensor node nₖ in descending order to obtain a list Ûₖ=[ûₖ¹, . . . , ûₖ^{|nbr}^{ₖ}^{|}] where ûₖ^{c} is the hybrid potential field between sensor node nₖ and its c^{th} neighbor node \hat{m}ₖ^{c} after sorting;
1.3.2.4.4). traversing list Ûₖ from hybrid potential field ûₖ¹ to hybrid potential field ûₖ^{|nbr}^{ₖ}^{|} to choose a neighbor node as the parent node of sensor node nₖ:
1.3.2.4.4.1). letting c=1;
1.3.2.4.4.2). for sensor node ûₖ^{c}, checking whether a ring is formed after a corresponding edge (nₖ, \hat{m}ₖ^{c}) is added into edge set E, if yes, then performing step 1.3.2.4.4.3), otherwise, adding edge (nₖ, \hat{m}ₖ^{c}) into edge set E, then performing step 1.3.2.4.5);
1.3.2.4.4.3). if c=ûₖ^{|nbr}^{ₖ}^{|}, then calculating a minimum arborescence by using minimum directed spanning tree (MDST) algorithm and letting edge set E equal to a set of all edges in the minimum arborescence, then performing step 1.3.2.5), if c≠ûₖ^{|nbr}^{ₖ}^{|}, then letting c=c+1 and returning step 1.3.2.4.4.2);
1.3.2.4.5). letting i=i+1 and returning step 1.3.2.4.2);
1.3.2.5). generating a spanning tree according to edge set E, then in the spanning tree, taking sensor node nⱼ, namely the next hover node as a root node to calculate each node's routing by using breadth-first-search algorithm;
1.3.3). sending each sensor node's routing in package form to its corresponding sensor node through current routing by the UAV, whereafter each sensor node sends data to the next hover node, namely sensor node nⱼ through its received routing and the UAV flies to and hovers above the next hover node to collect data through the next hover node;
1.4). continuously performing step 1.3), until the energy of any sensor node is run out, the wireless sensor network is paralyzed, and then training the agent by using an actor-critic reinforcement learning algorithm, wherein the decision network of the agent is taken as an actor network, a critic network is set for instructing the learning of the actor network, state vector \vec{S} at the time of determining the next hover node is taken as the input of the actor network and the input of the critic network, the reward function in the process of training is calculated according to the lifetime of the wireless sensor network and the energy consumption of the whole sensor nodes, the calculating formula of the reward function is:

$${R}_{t} = \{ \begin{matrix}{R}_{E} , the WSN is still running at the {t}^{t h} next hover node determination \\ {R}_{E} + {R}_{T} , the WS N is paralyzed at the {t}^{t h} next hover node determination\end{matrix}$$

where Rₜ is the value of the reward function at t^{th} next hover node determination, R_{E} is a value that is set according to the energy consumption of the whole sensor nodes between the t^{th} next hover node determination and the (t−1)^{th} next hover node determination, the higher the energy consumption of the whole sensor nodes is, the bigger the value of R_{E} is, R_{T} is a reward when the WSN is paralyzed and set according to the lifetime of the WSN, the longer the lifetime of the WSN is, the bigger the value of R_{T} is the value;
1.5). repeating step 1.1) to step 1.4) to continuously update the weights of the actor network and the critic network until convergence;
(2). deploying the UAV and the WSN into the real environment
2.1). randomly choosing a sensor node as the hover node and calculating each node's routing according to the method of step 1.1);
2.2). writing the location, neighbor nodes and routing of each sensor node into a configuration file of itself and a configuration file of the UAV respectively, deploying an agent used for determining a hover node into the UAV, the decision network of the agent is the trained decision network of the agent in simulation environment in step (1).
2.3). deploying the sensor nodes into the real environment according their locations, letting the UAV hover above the hover node;
(3). continuously detecting the environment and collecting data, and sending the collected data to the hover node according to their routings at intervals of α seconds by all sensor sensors, then sending the collected data to the UAV by the hover node, when the UAV hovers above the hover node;
(4). determining a next hover node by the UAV according to the method of step 1.3.1), when every β rounds of transmissions of the sensor nodes are completed, and generating a new routing scheme by the UAV according to the method of step 1.3.2), then sending each sensor node's routing to its corresponding sensor node through current routing by the UAV and letting the UAV flies to and hovers above the next hover node to collect data through the next hover node according to the method of step 1.3.3).

The objectives of the present invention are realized as follows:

The present invention provides a method for optimizing the energy efficiency of wireless sensor network based on the assistance of unmanned aerial vehicle, which comprises two parts: training an agent deployed on a UAV in simulation environment by using an actor-critic reinforcement learning algorithm and determining a next hover node and generating a new routing scheme in real environment by the UAV through using the decision network of the agent. More details of the present invention are as follows: Firstly, collecting the state of the WSN through current routing scheme, and inputting the state of the WSN into the decision network of the agent to determine a next hover node; Secondly, based on the location of the next hover node, generating a new routing scheme by the UAV, and sending each sensor node's routing to its corresponding sensor node through current routing by the UAV; Lastly, after all sensor nodes have received their routings respectively, all sensor nodes send their collected data to the hover node through their routings respectively, and the UAV flies to and hovers above the next hover node to collect data through the next hover node, thus the data collection of the whole WSN is completed. Considering that the amounts of data forwarded by the sensor nodes are different, the rates of energy consumptions of the sensor nodes are also different, an online determination of the data collection scheme is adopted. When the residual energies of the sensor nodes relatively have changed, the UAV needs to determine a next hover node and generate a new routing scheme according to current state of the WSN, thus the energy efficiency of wireless sensor network is optimized and the lifetime of the WSN is maximized, the aims of the present invention are realized.

In addition, the present invention, a method for optimizing the energy efficiency of wireless sensor network based on the assistance of unmanned aerial vehicle, also has the following advantages:
1. The present invention has realized the data collection of WSN based on the assistance of UAV, in which a UAV can hover above any of sensors to collect the data of the whole WSN. Comparing to traditional the data collection of WSN base on fixed sink node, the present invention is more flexible, and can be better adapted to the relative changes of energies of the sensor nodes;
2. The present invention can avoid transmitting the redundant residual energy information between sensor nodes. The information is collected and distributed by a UAV, which reduces the energy consumption of sensor nodes and improves the efficiency of energy utilization of sensor node.
3. The present invention has designed a data collection scheme during normal operation of a WSN, which can adjust the hover and collection location of the UAV and the routing scheme in real time according to energy change of the sensor nodes in the WSN.
4. The present invention uses a deep reinforcement learning to determine a hover node, namely design a fly scheme for the UAV, making it adapted to the routing scheme and maximizing the lifetime of the WSN together. Comparing to heuristic scheme, the fly scheme can perform a determination more fast and more efficient.

### BRIEF DESCRIPTION OF THE DRAWING

The above and other objectives, features and advantages of the present invention will be more apparent from the following detailed description taken in conjunction with the accompanying drawings, in which:

FIG. 1 is a flow diagram of a method for optimizing the energy efficiency of wireless sensor network based on the assistance of unmanned aerial vehicle in accordance with the present invention;

FIG. 2 is a diagram of deployment locations of the sensor nodes in accordance with one embodiment of the present invention;

FIG. 3 is a diagram of neighbor nodes of sensor node n₁₅ in accordance with one embodiment of the present invention;

FIG. 4 is a flow diagram of training an agent in accordance with the present invention;

FIG. 5 is a flow diagram of determining a next hover node and generating a new routing scheme by the UAV in accordance with the present invention;

FIG. 6 is an architecture diagram of the neural network used for the decision network of an agent in accordance with one embodiment of the present invention;

FIG. 7(A) is a diagram of the location of hover node and the routing scheme at the very beginning in accordance with one embodiment of the present invention;

FIG. 7(B) is a diagram of the location of a next hover node and the routing scheme at the 100^{th} determining and generating in accordance with one embodiment of the present invention;

FIG. 7(C) is a diagram of the location of a next hover node and the routing scheme at the 200^{th} determining and generating in accordance with one embodiment of the present invention.

### DETAILED DESCRIPTION OF THE PREFERRED EMBODIMENT

Hereinafter, preferred embodiments of the present invention will be described with reference to the accompanying drawings. It should be noted that the similar modules are designated by similar reference numerals although they are illustrated in different drawings. Also, in the following description, a detailed description of known functions and configurations incorporated herein will be omitted when it may obscure the subject matter of the present invention.

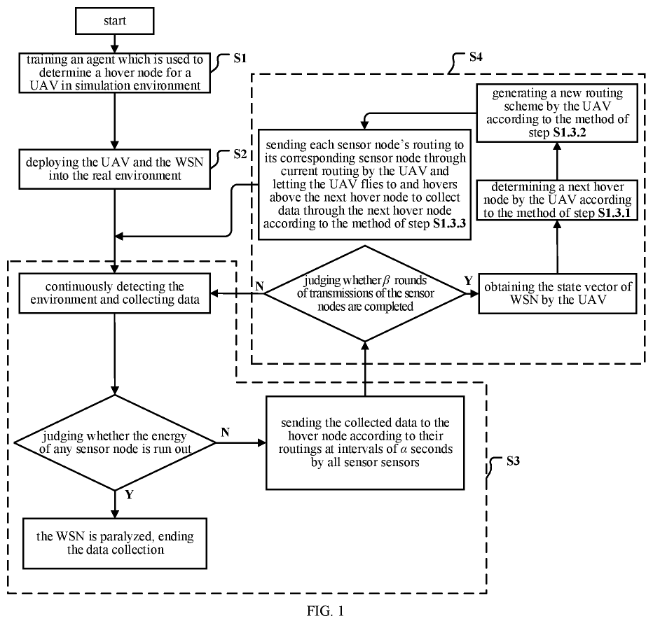

FIG. 1 is a flow diagram of a method for optimizing the energy efficiency of wireless sensor network based on the assistance of unmanned aerial vehicle in accordance with the present invention.

As shown in FIG. 1, a method for optimizing the energy efficiency of wireless sensor network (WSN) based on the assistance of unmanned aerial vehicle (UAV) is provided, which comprises:

Step S1: training an agent which is used to determine a hover node for a UAV in simulation environment

Creating a WSN based on an actual deployment in simulation environment, where the WSN has A battery-supplied sensor nodes and a sink node, the sink node is a UAV.

For sensor node nᵢ, i=1, . . . , A, taking the other sensor nodes within its communication range as its neighbor nodes to create a neighbor node list Nᵢ^{nbr}=[mᵢ¹, . . . , mᵢ^{|nbr}^{ᵢ}^{|}], where mᵢ^{c} is the c^{th} neighbor node of sensor node nᵢ, c=1, . . . , |nbrᵢ|, |nbrᵢ| is the number of neighbor nodes of sensor node nᵢ.

Deploying an agent on the UAV to determine a hover node for the UAV, where the hover node is the sensor node above which the UAV hovers to collect the whole data of the WSN.

In one embodiment, as shown in FIG. 2, the WSN has 20 battery-supplied sensor nodes which are numbered by 1-20, namely sensor nodes n₁, . . . , n₂₀ and uniformly distributed within a circle of 100-meter radius.

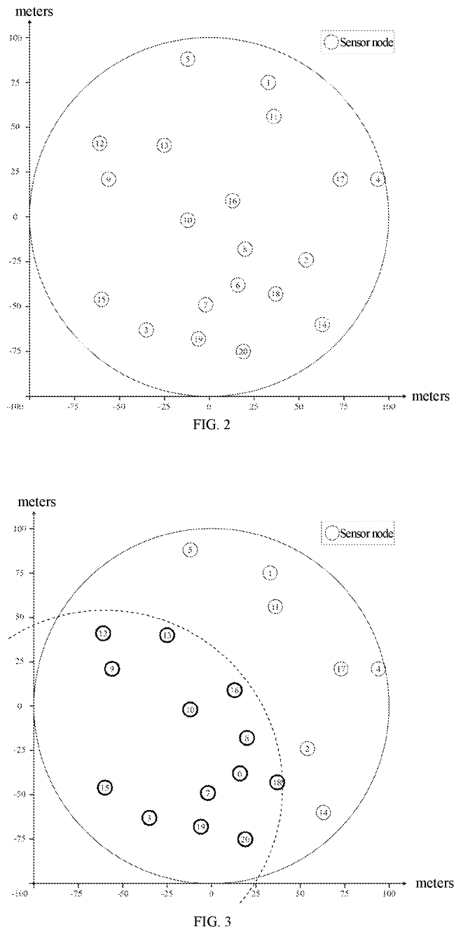

The UAV has enough energy to complete data collection assistance. the communication range of sensor node is R=100 meters due to the limit of rated power. For sensor node nᵢ, i=1, . . . , 20, its neighbor node list is Nᵢ^{nbr}=[mᵢ¹, . . . mᵢ^{|nbr}^{ᵢ}^{|}]. The other sensor nodes within the communication range of sensor node nᵢ, namely dist(mᵢ^{c}, nᵢ)≤100 meters constitute neighbor node list Nᵢ^{nbr}, where dist(mᵢ^{c}, nᵢ) is the distance between sensor node mf and sensor node nᵢ, c=1, . . . , |nbrᵢ|, |nbrᵢ| is the number of neighbor nodes of sensor node nᵢ. As shown in FIG. 3, the nodes within the dashed line and with bold circle are neighbor nodes of sensor node n₁₅, the neighbor node list of sensor node n₁₅ can be expressed as:

$${N}_{15}^{n b r} = [ {m}_{15}^{1} , {m}_{15}^{2} , {m}_{15}^{3} , {m}_{15}^{4} , {m}_{15}^{5} , {m}_{15}^{6} , {m}_{15}^{7} , {m}_{15}^{8} , {m}_{15}^{9} , {m}_{15}^{10} , {m}_{15}^{11} , {m}_{15}^{12} ]$$

$$= [ {n}_{3} , {n}_{6} , {n}_{7} , {n}_{8} , {n}_{9} , {n}_{10} , {n}_{12} , {n}_{13} , {n}_{16} , {n}_{18} , {n}_{19} , {n}_{20} ] .$$

In one embodiment, the hovering height of the UAV is h=50 meters. all sensor nodes perform a round of data transmission at intervals of α=600 seconds, namely each sensor transmits collected data to a hover node after it collects data 600 seconds. All sensor nodes have enough time and a certain storage to complete their data transmission. In addition, the UAV has enough time to fly to a next hover node and enough energy to fly, hover and transmit. when every β rounds of transmissions of the sensor nodes are completed, the decision network of the agent deployed on the UAV will perform a next hover node determination and generate a new routing scheme base on the next hover node determination.

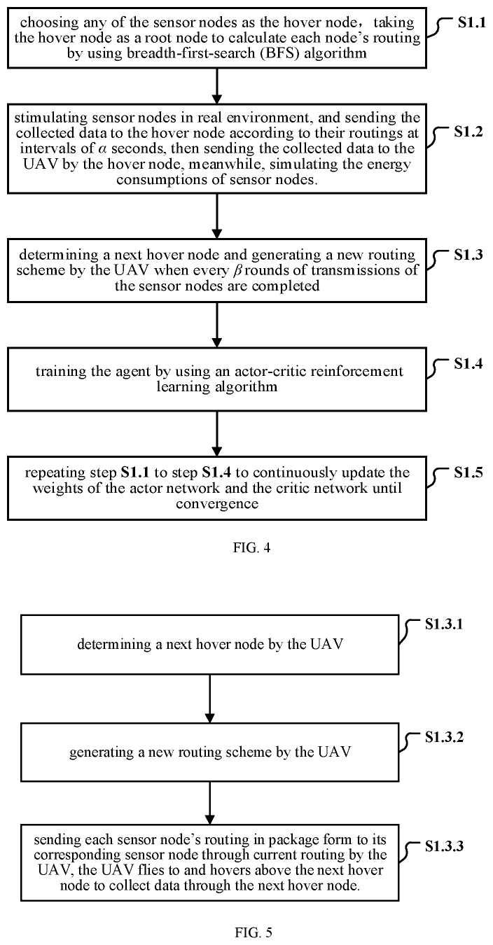

Training the agent by using an actor-critic reinforcement learning algorithm, as shown in FIG. 4, which comprises the following steps:
Step S1.1: choosing any of the sensor nodes as the hover node, then based on the locations where the sensors deployed and the neighborhood relationships between the sensors, taking the distances between the sensors as weights to calculate a minimum spanning tree by using Kruskal algorithm, and then in the minimum spanning tree, taking the hover node as a root node to calculate each node's routing by using breadth-first-search (BFS) algorithm.
Step S1.2: for the different data that sensor nodes need to collect, designing their probability distributions respectively based on existing prior knowledge to simulate the amount of data collected by sensor nodes in a real environment, and sending the collected data to the hover node according to their routings at intervals of α=600 seconds, then sending the collected data to the UAV by the hover node, when the UAV hovers above the hover node, meanwhile, simulating the energy consumptions of sensor nodes.
Step S1.3: determining a next hover node and generating a new routing scheme by the UAV when every β=10 rounds of transmissions of the sensor nodes are completed. As shown FIG. 5, the process of determining and generating are as follows:
Step S1.3.1: determining a next hover node by the UAV
Step S1.3.1.1: for sensor node nᵢ, i=1, . . . , A, sending its residual energy to the UAV through current routing, and normalizing the residual energy in the UAV to obtain its normalized residual energy Wᵢ, thus a residual energy vector \vec{W}=[W₁, . . . , W_{A}] of the sensor nodes is obtained. In one embodiment, residual energy vector \vec{W}=[W₁, . . . , W₂₀].
Step S1.3.1.2: obtaining a location vector \vec{L}=[(l₁¹, l₁²), . . . , (l_{A}¹, l_{A}²)] of the sensor nodes by the UAV according to the locations of the sensor nodes, where lᵢ¹ and lᵢ² correspond to the normalized horizontal coordinate and the normalized vertical coordinate of sensor node nᵢ in a fixed coordinate system respectively. In one embodiment, location vector \vec{L}=[(l₁¹, l₁²), . . . , (l₂₀¹, l₂₀²)].
Step S1.3.1.3: concatenating residual energy vector \vec{W} and location vector \vec{L} to obtain a state vector \vec{S}=\vec{L}+\vec{W} and sending the state vector S to the decision network of the agent to calculate a probability vector \vec{P}=[p₁, . . . , p_{A}] by the UAV, where pᵢ, i=1, . . . , A is the probability of choosing sensor node nᵢ as a next hover node by the UAV. In one embodiment, probability vector \vec{P}=[p₁, . . . , p₂₀]. The concrete value of probability vector is:

\vec{P}=[0.4,0,0,0.1,0,0,0.1,0,0,0.1,0,0,0.1, 0, 0, 0, 0.1,0,0,0.1].

Then the corresponding cumulative distribution function vector is:
[0.4, 0.4, 0.4, 0.5, 0.5, 0.5, 0.6, 0.6, 0.6, 0.7, 0.7, 0.7, 0.8, 0.8, 0.8, 0.8, 0.9, 0.9, 0.9, 1].
Step S1.3.1.4: randomly generating a floating number within the range of (0,1] by the UAV, wherein if the floating number fall in the j^{th} interval of the cumulative distribution function vector of probability vector \vec{P}, the j^{th} sensor node nⱼ is chosen as the next hover node.

In one embodiment, the randomly generated floating number is 0.43, which fall in the 4^{th} interval of the cumulative distribution function vector, then the 4^{th} sensor node n₄ is chosen as the next hover node. It should be noted that the first interval is 0 to first element of the cumulative distribution function vector.
Step S1.3.2: generating a new routing scheme by the UAV
Step S1.3.2.1: for sensor node nᵢ, i=1, . . . , A, using energy-balanced routing protocol (EBRP) algorithm to calculate its hybrid potential field list Uᵢ=[uᵢ¹, . . . , uᵢ^{|nbr}^{ᵢ}^{|}] according to its neighbor node list Nᵢ^{nbr} by the UAV, where uᵢ^{c} is the hybrid potential field between sensor node nᵢ and its neighbor node mᵢ^{c}, the value of uᵢ^{c} stands for the preference of choosing neighbor node mᵢ^{c} as parent node, the bigger the value is, the stronger the preference is. The detailed calculation process is described in document “EBRP: energy-balanced routing protocol for data gathering in wireless sensor networks”, Ren F, Zhang J, He T, et al. IEEE transactions on parallel and distributed systems, 2011, 22(12): 2108-2125.
Step S1.3.2.2: for sensor node nᵢ, i=1, . . . , A, calculating the distance to the next hover node according to its location by the UAV, sorting the sensor nodes in descending order by distance to obtain a node list \hat{N}=[\hat{n}₁, . . . , \hat{n}_{A}], where \hat{n}ᵢ is the i^{th} sensor node in node list \hat{N}.
Step S1.3.2.3: maintaining an edge set E by the UAV, wherein the edges of edge set E is used to generate a spanning tree, the root node of the spanning tree is sensor node \hat{n}_{A}=nⱼ, initializing edge set E to an empty set.
Step S1.3.2.4: traversing node list \hat{N} from sensor node \hat{n}₁ to sensor node \hat{n}_{A} to choose a parent node for each sensor node by the UAV, namely directing the sensor nodes to transmit data to the next hover node by choosing parent nodes for the sensor nodes from far to near distance to the next hover node.
Step S1.3.2.4.1: letting i=1.
Step S1.3.2.4.2: for sensor node \hat{n}ᵢ, if i=A, then performing step S1.3.2.5, if i≠A, then performing step 1.3.2.4.3.
Step S1.3.2.4.3: wherein sensor node \hat{n}ᵢ corresponds to sensor node nₖ, sorting hybrid potential field list Uᵢ of sensor node nₖ in descending order to obtain a list Ûₖ=[ûₖ¹, . . . , ûₖ^{|nbr}^{ₖ}^{|}] where ûₖ^{c} is the hybrid potential field between sensor node nₖ and its c^{th} neighbor node \hat{m}ₖ^{c} after sorting.
Step S1.3.2.4.4: traversing list Ûₖ from hybrid potential field ûₖ¹ to hybrid potential field ûₖ^{|nbr}^{ₖ}^{|} to choose a neighbor node as the parent node of sensor node nₖ:
Step S1.3.2.4.4.1: letting c=1;
Step S1.3.2.4.4.2: for sensor node ûₖ^{c}, checking whether a ring is formed after a corresponding edge (nₖ, \hat{m}ₖ^{c}) is added into edge set E, if yes, then performing step S1.3.2.4.4.3, otherwise, adding edge (nₖ, \hat{m}ₖ^{c}) into edge set E, then performing step S1.3.2.4.5;
Step S1.3.2.4.4.3: if c=ûₖ^{|nbr}^{ₖ}^{|}, then calculating a minimum arborescence by using minimum directed spanning tree (MDST) algorithm and letting edge set E equal to a set of all edges in the minimum arborescence, then performing step S1.3.2.5, if c≠ûₖ^{|nbr}^{ₖ}^{|}, then letting c=c+1 and returning step S1.3.2.4.4.2. MDST algorithm is described in “Efficient algorithms for finding minimum spanning trees in undirected and directed graphs”, Gabow H N, Galil Z, Spencer T, et al. Combinatorica, 1986, 6(2): 109-122.
Step S1.3.2.4.5: letting i=i+1 and returning step 1.3.2.4.2.
Step S1.3.2.5: generating a spanning tree according to edge set E, then in the spanning tree, taking sensor node nⱼ, namely the next hover node as a root node to calculate each node's routing by using breadth-first-search algorithm.
Step S1.3.3: sending each sensor node's routing in package form to its corresponding sensor node through current routing by the UAV, whereafter each sensor node sends data to the next hover node, namely sensor node n through its received routing and the UAV flies to and hovers above the next hover node to collect data through the next hover node.
Step S1.4: continuously performing step S1.3, until the energy of any sensor node is run out, the wireless sensor network is paralyzed, and then training the agent by using an actor-critic reinforcement learning algorithm, wherein the decision network of the agent is taken as an actor network, a critic network is set for instructing the learning of the actor network, state vector S at the time of determining the next hover node is taken as the input of the actor network and the input of the critic network, the reward function in the process of training is calculated according to the lifetime of the wireless sensor network and the energy consumption of the whole sensor nodes, the calculating formula of the reward function is:

$${R}_{t} = \{ \begin{matrix}{R}_{E} , the WSN is still running at the {t}^{t h} next hover node determination \\ {R}_{E} + {R}_{T} , the WS N is paralyzed at the {t}^{t h} next hover node determination\end{matrix}$$

where Rₜ is the value of the reward function at t^{th} next hover node determination, R_{E} is a value that is set according to the energy consumption of the whole sensor nodes between the t^{th} next hover node determination and the (t−1)^{th} next hover node determination, the higher the energy consumption of the whole sensor nodes is, the bigger the value of R_{E} is, R_{T} is a reward when the WSN is paralyzed and set according to the lifetime of the WSN, the longer the lifetime of the WSN is, the bigger the value of R_{T} is the value.

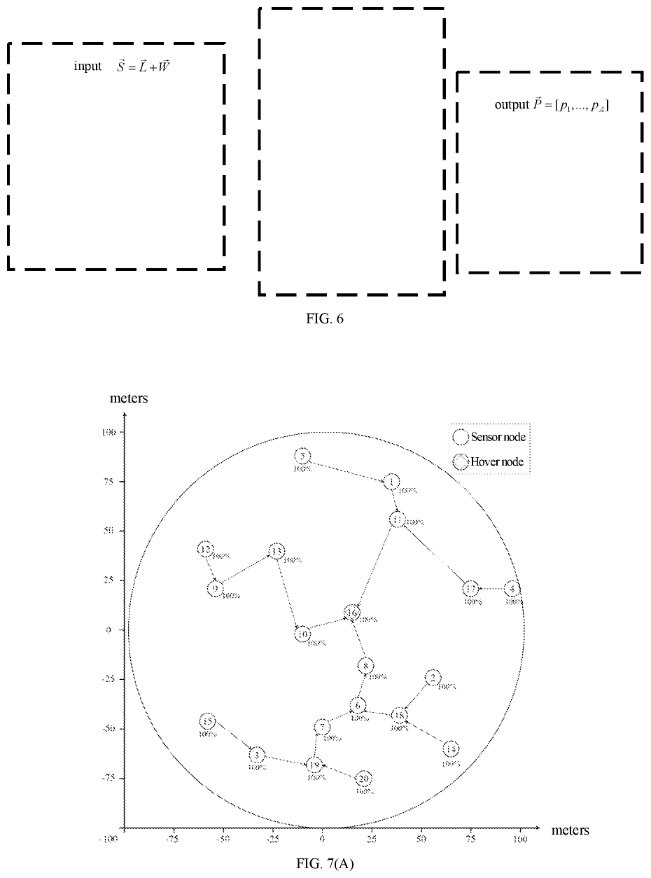

In one embodiment, as shown in FIG. 6, the actor network, namely the decision network of the final deployed agent comprises two fully connected layers of width of 512 and a Softmax layer, the activation function of the fully connected layer is rectified linear unit (ReLU) function. State vector \vec{S} is sent to the two fully connected layers, and the output is sent to the Softmax layer to obtain probability vector \vec{P}.

In one embodiment, both of the actor network and the critic network are trained by adaptive moment estimation optimizer. The learning rate of the actor network is 1×10⁻⁵, The learning rate of the critic network is 1×10⁻⁴. To guarantee the stability of training, generalized advantage estimator (GAE) is used to perform an advantage function estimation. To guarantee the exploration intensity of the actor network and prevent it from early failing into local optimal solution, an entropy regularization term is added into its loss function. Entropy regularization weight is set to 0.01. The trainings of the actor network and the critic network belong to prior art, so no more details are described here.
Step S1.5: repeating step S1.1 to step S1.4 to continuously update the weights of the actor network and the critic network until convergence.
Step S2: deploying the UAV and the WSN into the real environment
Step S2.1: randomly choosing a sensor node as the hover node and calculating each node's routing according to the method of step S1.1.
Step S2.2: writing the location, neighbor nodes and routing of each sensor node into a configuration file of itself and a configuration file of the UAV respectively, deploying an agent used for determining a hover node into the UAV, the decision network of the agent is the trained decision network of the agent in simulation environment in step S1.
Step S2.3: deploying the sensor nodes into the real environment according their locations, letting the UAV hover above the hover node.
Step S3: continuously detecting the environment and collecting data, and judging whether the energy of any sensor node is run out, if yes, the WSN is paralyzed, ending the data collection, if the energies of all sensor nodes aren't run out, and sending the collected data to the hover node according to their routings at intervals of α seconds by all sensor sensors, then sending the collected data to the UAV by the hover node, when the UAV hovers above the hover node.
Step S4: determining a next hover node by the UAV according to the method of step S1.3.1, when every β rounds of transmissions of the sensor nodes are completed, and generating a new routing scheme by the UAV according to the method of step S1.3.2, then sending each sensor node's routing to its corresponding sensor node through current routing by the UAV and letting the UAV flies to and hovers above the next hover node to collect data through the next hover node according to the method of step S1.3.3.

In one embodiment, as shown in FIG. 1, the detailed steps of Step S4 are: judging whether β rounds of transmissions of the sensor nodes are completed, if no, returning to step S3, if yes, obtaining the state vector of WSN by the UAV, determining a next hover node by the UAV according to the method of step S1.3.1, and generating a new routing scheme by the UAV according to the method of step S1.3.2, then sending each sensor node's routing to its corresponding sensor node through current routing by the UAV and letting the UAV flies to and hovers above the next hover node to collect data through the next hover node according to the method of step S1.3.3, then returning to S3.

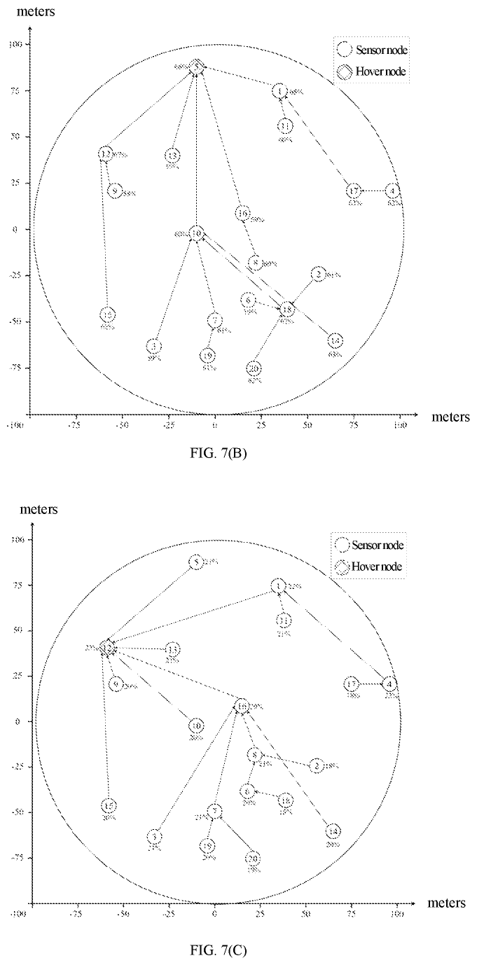

FIG. 7(A), FIG. 7(B) and FIG. 7(c) show the locations of hover node and the routing schemes at the very beginning, at the 100^{th} determining and generating and at the 200^{th} determining and generating respectively. In the figures, the percentage next to a sensor node number is the percentage of residual energy of the sensor node. As we can see from the figures that the location of hover node changes constantly, the residual energies of all sensor nodes also reduce constantly, however, the residual energies of the sensor nodes are balanced, thus the lifetime of WSN is maximized.

To demonstrate the advantage of the present invention, a specific example is given to verify and the WSN as shown in FIG. 2 is adopted. In the specific example, two methods of determining hover node are chosen as comparison and adopt the same routing algorithm of the sensor nodes. In method 1 (Random), the hover node is chosen randomly from the sensor nodes. In method 2 (Greedy), the sensor node which energy consumption is the minimal is chosen as a next hover node, when every β=10 rounds of transmissions of the sensor nodes are completed. Then comparing the lifetime of WSN in the present invention to that in method 1 and method 2. The comparison results are shown in table1.

TABLE 1

| | | | The present |
|---|---|---|---|
| Method | Random | Greedy | invention |
| The lifetime of WSN | 1514 | 2179 | 2436 |
| (rounds of transmissions) | | | |

From table 1, we can see that the present invention can make the lifetime of WSN longer, the lifetime of WSN in present invention is 1.6 times of that in method 1 (Random) and 1.11 times of that in method 2 (Greedy), which has verified that the present invention can maximize the lifetime of WSN.

While illustrative embodiments of the invention have been described above, it is, of course, understand that various modifications will be apparent to those of ordinary skill in the art. Such modifications are within the spirit and scope of the invention, which is limited and defined only by the appended claims.

What is claimed is:

1. A method for optimizing the energy efficiency of wireless sensor network (WSN) based on the assistance of unmanned aerial vehicle (UAV), comprising:
training an agent which is used to determine a hover node for a UAV in simulation environment creating a WSN based on an actual deployment in simulation environment, where the WSN has A battery-supplied sensor nodes and a sink node, the sink node is a UAV;
for sensor node nᵢ, i=1, . . . , A, taking the other sensor nodes within its communication range as its neighbor nodes to create a neighbor node list Nᵢ^{nbr}=[mᵢ¹, . . . , mᵢ^{|nbr}^{ᵢ}^{|}] where mᵢ^{c} is the c^{th} neighbor node of sensor node nᵢ, c=1, . . . , |nbrᵢ|, |nbrᵢ| is the number of neighbor nodes of sensor node nᵢ;
deploying an agent on the UAV to determine a hover node for the UAV, where the hover node is the sensor node above which the UAV hovers to collect the whole data of the WSN;
training the agent by using an actor-critic reinforcement learning algorithm:
1.1). choosing any of the sensor nodes as the hover node, then based on the locations where the sensors deployed and the neighborhood relationships between the sensors, taking the distances between the sensors as weights to calculate a minimum spanning tree by using Kruskal algorithm, and then in the minimum spanning tree, taking the hover node as a root node to calculate each node's routing by using breadth-first-search algorithm;
1.2). for the different data that the sensor nodes need to collect, designing their probability distributions respectively based on existing prior knowledge to simulate the amount of data collected by sensor nodes in a real environment, and sending the collected data to the hover node according to their routings at intervals of α seconds, then sending the collected data to the UAV by the hover node, when the UAV hovers above the hover node, meanwhile, simulating the energy consumptions of sensor nodes;
1.3). determining a next hover node and generating a new routing scheme by the UAV when every β rounds of transmissions of the sensor nodes are completed, wherein the process of determining and generating are as follows:
1.3.1). determining a next hover node by the UAV
1.3.1.1). for sensor node nᵢ, i=1, . . . , A, sending its residual energy to the UAV through current routing, and normalizing the residual energy in the UAV to obtain its normalized residual energy Wᵢ, thus a residual energy vector \vec{W}=[W₁, . . . , W_{A}] of the sensor nodes is obtained;
1.3.1.2). obtaining a location vector \vec{L}=[(l₁¹, l₁²), . . . , (l_{A}¹, l_{A}²)] of the sensor nodes by the UAV according to the locations of the sensor nodes, where lᵢ¹ and lᵢ² correspond to the normalized horizontal coordinate and the normalized vertical coordinate of sensor node nᵢ in a fixed coordinate system respectively;
1.3.1.3). concatenating residual energy vector \vec{W} and location vector \vec{L} to obtain a state vector \vec{S}=\vec{L}+\vec{W} and sending the state vector \vec{S} to the decision network of the agent to calculate a probability vector \vec{P}=[p₁, . . . , p_{A}] by the UAV, where pᵢ, i=1, . . . , A is the probability of choosing sensor node nᵢ as a next hover node by the UAV;
1.3.1.4). randomly generating a floating number within the range of (0,1] by the UAV, wherein if the floating number fall in the j^{th} interval of the cumulative distribution function vector of probability vector \vec{P}, the j^{th} sensor node nⱼ is chosen as the next hover node.
1.3.2). generating a new routing scheme by the UAV
1.3.2.1). for sensor node nᵢ, i=1, . . . , A, using energy-balanced routing protocol (EBRP) algorithm to calculate its hybrid potential field list Uᵢ=[uᵢ¹, . . . , uᵢ^{|nbr}^{ᵢ}^{|}] according to its neighbor node list Nᵢ^{nbr} by the UAV, where uᵢ^{c} is the hybrid potential field between sensor node nᵢ and its neighbor node mᵢ^{c}, the value of uᵢ^{c} stands for the preference of choosing neighbor node mᵢ^{c} as parent node, the bigger the value is, the stronger the preference is;
1.3.2.2). for sensor node nᵢ, i=1, . . . , A, calculating the distance to the next hover node according to its location by the UAV, sorting the sensor nodes in descending order by distance to obtain a node list \hat{N}=[\hat{n}₁, . . . , \hat{n}_{A}], where \hat{n}ᵢ is the i^{th} sensor node in node list \hat{N};
1.3.2.3). maintaining an edge set E by the UAV, wherein the edges of edge set E is used to generate a spanning tree, the root node of the spanning tree is sensor node \hat{n}_{A}=nⱼ, initializing edge set E to an empty set;
1.3.2.4). traversing node list \hat{N} from sensor node \hat{n}₁ to sensor node \hat{n}_{A} to choose a parent node for each sensor node by the UAV, namely directing the sensor nodes to transmit data to the next hover node by choosing parent nodes for the sensor nodes from far to near distance to the next hover node:
1.3.2.4.1). letting i=1;
1.3.2.4.2). for sensor node \hat{n}ᵢ, if i=A, then performing step 1.3.2.5), if i≠A, then performing step 1.3.2.4.3);
1.3.2.4.3). wherein sensor node \hat{n}ᵢ corresponds to sensor node nₖ, sorting hybrid potential field list Uᵢ of sensor node nₖ in descending order to obtain a list Ûₖ=[ûₖ¹, . . . , ûₖ^{|nbr}^{ₖ}^{|}] where ûₖ^{c} is the hybrid potential field between sensor node nₖ and its c^{th} neighbor node \hat{m}ₖ^{c} after sorting;
1.3.2.4.4). traversing list Ûₖ from hybrid potential field ûₖ¹ to hybrid potential field ûₖ^{|nbr}^{ₖ}^{|} to choose a neighbor node as the parent node of sensor node nₖ:
1.3.2.4.4.1). letting c=1;
1.3.2.4.4.2). for sensor node ûₖ^{c}, checking whether a ring is formed after a corresponding edge ûₖ^{|nbr}^{ₖ}^{|} is added into edge set E, if yes, then performing step 1.3.2.4.4.3), otherwise, adding edge (nₖ, \hat{m}ₖ^{c}) into edge set E, then performing step 1.3.2.4.5);
1.3.2.4.4.3). if c=ûₖ^{|nbr}^{ₖ}^{|}, then calculating a minimum arborescence by using minimum directed spanning tree (MDST) algorithm and letting edge set E equal to a set of all edges in the minimum arborescence, then performing step 1.3.2.5), if c≠ûₖ^{|nbr}^{ₖ}^{|}, then letting c=c+1 and returning step 1.3.2.4.4.2);
1.3.2.4.5). letting i=i+1 and returning step 1.3.2.4.2);
1.3.2.5). generating a spanning tree according to edge set E, then in the spanning tree, taking sensor node n₁, namely the next hover node as a root node to calculate each node's routing by using breadth-first-search algorithm;
1.3.3). sending each sensor node's routing in package form to its corresponding sensor node through current routing by the UAV, whereafter each sensor node sends data to the next hover node, namely sensor node nⱼ through its received routing and the UAV flies to and hovers above the next hover node to collect data through the next hover node;
1.4). continuously performing step 1.3), until the energy of any sensor node is run out, the wireless sensor network is paralyzed, and then training the agent by using an actor-critic reinforcement learning algorithm, wherein the decision network of the agent is taken as an actor network, a critic network is set for instructing the learning of the actor network, state vector \vec{S} at the time of determining the next hover node is taken as the input of the actor network and the input of the critic network, the reward function in the process of training is calculated according to the lifetime of the wireless sensor network and the energy consumption of the whole sensor nodes, the calculating formula of the reward function is:
$${R}_{t} = \{ \begin{matrix}{R}_{E} , & the WSN is still running at the {t}^{t h} next hover node determination \\ {R}_{E} + {R}_{T} , & the WS N is paralyzed at the {t}^{t h} next hover node determination\end{matrix}$$
where Rₜ is the value of the reward unction at t^{th} next over node determination, R_{E} is a value that is set according to the energy consumption of the whole sensor nodes between the t^{th} next hover node determination and the (t−1)^{th} next hover node determination, the higher the energy consumption of the whole sensor nodes is, the bigger the value of R_{E} is, R_{T} is a reward when the WSN is paralyzed and set according to the lifetime of the WSN, the longer the lifetime of the WSN is, the bigger the value of R_{T} is the value;
1.5). repeating step 1.1) to step 1.4) to continuously update the weights of the actor network and the critic network until convergence;
(2). deploying the UAV and the WSN into the real environment
2.1). randomly choosing a sensor node as the hover node and calculating each node's routing according to the method of step 1.1);
2.2). writing the location, neighbor nodes and routing of each sensor node into a configuration file of itself and a configuration file of the UAV respectively, deploying an agent used for determining a hover node into the UAV, the decision network of the agent is the trained decision network of the agent in simulation environment in step (1).
2.3). deploying the sensor nodes into the real environment according their locations, letting the UAV hover above the hover node;
(3). continuously detecting the environment and collecting data, and sending the collected data to the hover node according to their routings at intervals of α seconds by all sensor sensors, then sending the collected data to the UAV by the hover node, when the UAV hovers above the hover node;
(4). determining a next hover node by the UAV according to the method of step 1.3.1), when every β rounds of transmissions of the sensor nodes are completed, and generating a new routing scheme by the UAV according to the method of step 1.3.2), then sending each sensor node's routing to its corresponding sensor node through current routing by the UAV and letting the UAV flies to and hovers above the next hover node to collect data through the next hover node according to the method of step 1.3.3).
